(19) United States
(12) Patent Application Publication
(10) Pub. No.: US 2022/0330751 A1
(43) Pub. Date: Oct. 20, 2022

(54) PORTABLE BARBEQUES AND PIZZA OVENS

(71) Applicant: Sapphire Sail Pty Ltd, Temora (AU)

(72) Inventor: John Desmond SMITH, Temora (AU)

(21) Appl. No.: 17/232,610

(22) Filed: Apr. 16, 2021

(51) Int. Cl. A47J 37/07

(52) U.S. Cl. CPC A47J 37/0786; A47J 37/0763; A47J 2037/0777

(57) ABSTRACT

A hood extension device 10 for a portable BBQ and pizza oven has four interconnected side walls forming a four cornered frame when the device is in the opened condition for use. A first opposed pair 12, 14 of the side walls of the opened hood extension device 10 have 180° piano hinges 16, 18 located half way along their length, and each of the four corners have 90° piano hinges 20, 22, 24, 26. The arrangement is such that the first opposed pair 12, 14 of the side walls can be folded inwardly, concertina-like, when required for the device 10 to assume the closed condition for easy flat-pack storage and transportation, and can be folded outwardly when required for the device 10 to assume the opened condition for use.

### TECHNICAL FIELD

The present inventions relate to improvements in portable barbeques (hereinafter referred to as “BBQ”) and pizza ovens.

In particular, a first invention relates to a hood extension device for a portable BBQ and pizza oven.

A second invention relates to a storage enclosure for a portable BBQ and pizza oven.

A third invention relates to a drawer slide system for a portable BBQ and pizza oven. A fourth invention relates to a locking clip system for a portable BBQ and pizza oven.

### BACKGROUND ART

The function and design of conventional portable BBQ's and pizza ovens has often ignored the desirability that these products be versatile in their use, easy to store and transport, easily accessible for use, space saving when being transported, and stable and removably securable when in use.

### SUMMARY OF INVENTIONS

It is an object of the present inventions to overcome the aforementioned shortcomings and deficiencies of the prior art, or at least provide useful alternatives.

According to the first invention, there is provided a hood extension device for a portable BBQ or pizza oven, the device comprising four interconnected side walls forming a four cornered frame when the device is in an opened condition for use, a first opposed pair of the side walls having 180° hinges located half way along their length, and each of the four corners have 90° hinges, the arrangement being such that the first opposed pair of the side walls can be folded inwardly, concertina-like, when required for the device to assume a closed condition for easy flat-pack storage and transportation, and can be folded outwardly when required for the device to assume the opened condition for use, whereby the device can be mounted on a base portion of a portable BBQ or pizza oven, and a hood of the same portable BBQ or pizza oven can be mounted on top of the device to provide a sealed, enlarged and protected cooking space within the portable BBQ or pizza oven.

According to the second invention, there is provided storage enclosure for a portable BBQ and pizza oven, the storage enclosure comprising a deep walled part that is mounted for use in a vertical orientation, and a pivotally connected lid part to which a base portion, and optionally a drawer slide system of the storage enclosure, of the portable BBQ or pizza oven is mounted, whereby, to open the storage enclosure, the lid part folds down to bring it parallel to the ground so that the portable BBQ or pizza oven is parallel to the ground, and wherein the width of the storage enclosure is a little more than twice that of the portable BBQ or pizza oven so that a hood of the portable BBQ or pizza oven can fit and be stored to the side of the mounted base portion.

According to the third invention, there is provided a drawer slide system for a portable BBQ and pizza oven, the system comprising a first reference surface below the portable BBQ or pizza oven and relative to which a second movable surface upon which the portable BBQ or pizza oven is mounted can slide into and out of a storage compartment.

In a preferred form, at each side of the portable BBQ or pizza oven are foldable side trays which, when the portable BBQ or pizza oven is slid out of the storage compartment and locked into place, can be folded outwardly to support food and other items required for cooking, and wherein the side trays can be folded up alongside the portable BBQ or pizza oven after use and locked into a vertical position to serve as narrow storage compartments.

According to the fourth invention, there is provided a locking clip system for a portable BBQ and pizza oven, the system comprising a rear lock bracket secured to a surface upon which the portable BBQ or pizza oven is supported, the rear lock bracket being adapted to receive one or more rear feet of the portable BBQ or pizza oven so as to stably, but removably, lock the portable BBQ or pizza oven in position on the surface, and wherein the portable BBQ or pizza oven can be unclipped from the surface and, optionally, be placed in a carry bag for taking elsewhere.

### SUMMARY OF THE DRAWINGS

FIG. 1 is an isometric view of an embodiment of a hood extension device, in an opened condition, for a portable BBQ and pizza oven.

FIG. 2 is a front isometric view of an assembly in which the hood extension device of FIG. 1 is operably connected to a portable BBQ with the use of clamps.

FIG. 3 is a rear isometric view of the assembly shown in FIG. 2.

FIG. 4 is a front elevation view of the assembly shown in FIGS. 2 and 3.

FIG. 5 is a front isometric view of the hood extension device of FIG. 1, in a collapsed condition, for storage and transportation.

FIG. 6 is a front isometric view of the assembly shown in FIG. 2 mounted on an embodiment of a storage enclosure.

FIG. 7 is a side elevation view of the assembly shown in FIG. 6.

FIG. 8 is a front isometric view of the assembly shown in FIG. 2 mounted to an embodiment of a drawer slide system, and also showing foldable side trays.

FIG. 9 is a front elevation view of the assembly shown in FIG. 8.

FIG. 10 is a side elevation view of the assembly shown in FIGS. 8 and 9.

FIG. 11 is a front isometric view of a rear lock bracket of an embodiment of a locking clip system for receiving the rear feet of a portable BBQ and pizza oven.

FIG. 12 is a front isometric view of the assembly shown in FIG. 2 mounted on a mobile stand or trolley with the use of feet which engage the rear lock bracket.

FIG. 13 is a side elevation view of the assembly shown in FIG. 12.

FIG. 14 is a front isometric view of an assembly similar to that of FIGS. 2 to 4 but with the hood removed and replaced with a rotisserie arrangement mounted on the hood extension device.

FIG. 15 is an isometric view of the hood extension device of FIG. 1 but shown in more detail, in an opened condition.

FIG. 16 is an enlarged isometric view of a portion of the hood extension device of FIG. 15 that includes a 180° piano hinge and a slide lock arrangement for locking the device in the opened condition.

FIG. 17 is another isometric view of the hood extension device of FIGS. 15 and 16 but with some of the components of the slide lock arrangement removed and shown independently.

FIG. 18 is an enlarged isometric view of an alternative spring lock arrangement for locking the hood extension device in the opened condition.

FIG. 19 is an isometric view of a hood extension device similar to that of FIGS. 1 and 15, which has been folded inwardly, concertina-like, to assume a partly closed condition.

FIG. 20 is a front isometric view of an assembly similar to that of FIGS. 2 to 4 but with bracket assemblies connected to the front and rear of the bottom of the base portion.

FIG. 21 is a rear isometric view of the assembly shown in FIG. 20.

### DETAILED DESCRIPTION OF PREFERRED FORMS OF THE INVENTIONS

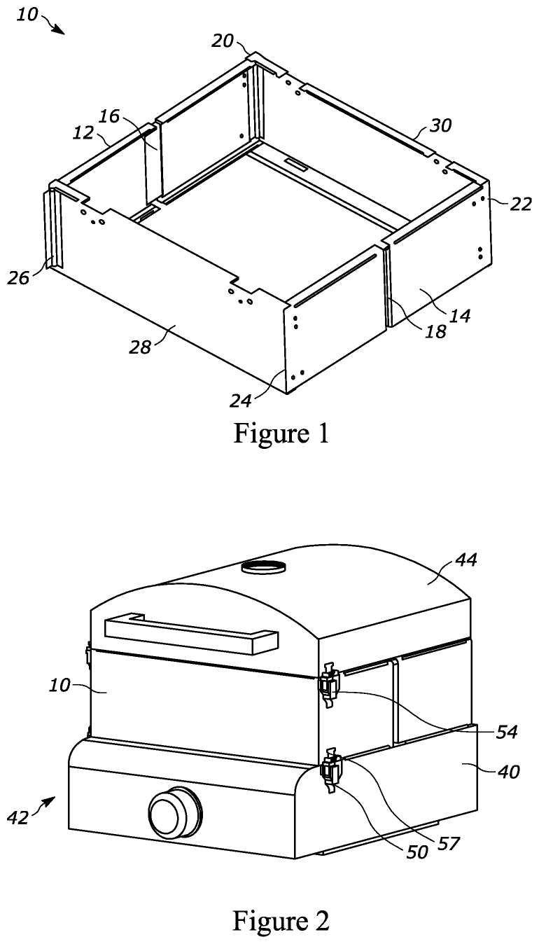

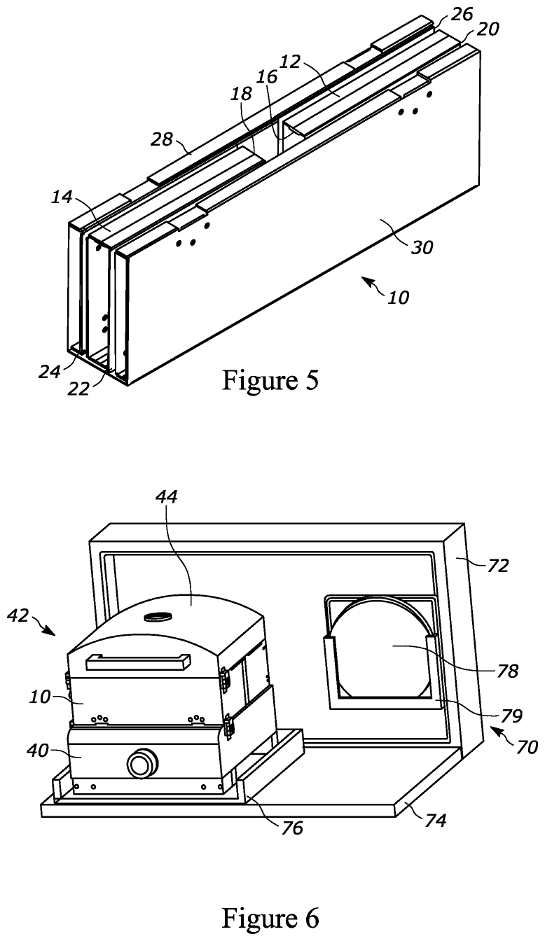

The hood extension device 10 shown, in an opened condition in FIG. 1 and in a closed condition in FIG. 5, comprises four interconnected side walls forming a four cornered frame when the device is in the opened condition for use, and is made of stainless steel, which is the same material from which the portable BBQ and pizza oven are made. A first opposed pair 12, 14 of the side walls of the opened hood extension device 10 have 180° piano hinges 16, 18 located half way along their length, and each of the four corners have 90° piano hinges 20, 22, 24, 26, the arrangement being such that the first opposed pair 12, 14 of the side walls can be folded inwardly, concertina-like, when required for the device 10 to assume the closed condition for easy flat-pack storage and transportation, and can be folded outwardly when required for the device 10 to assume the opened condition for use.

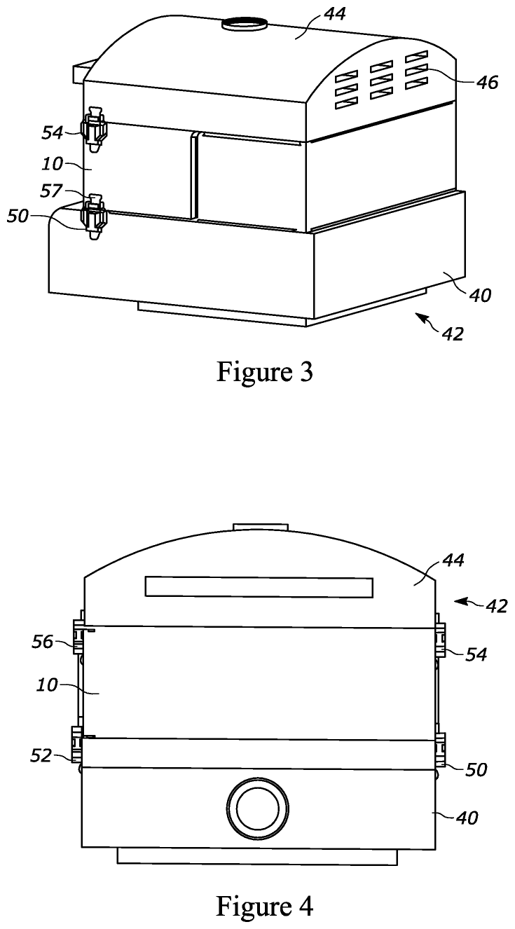

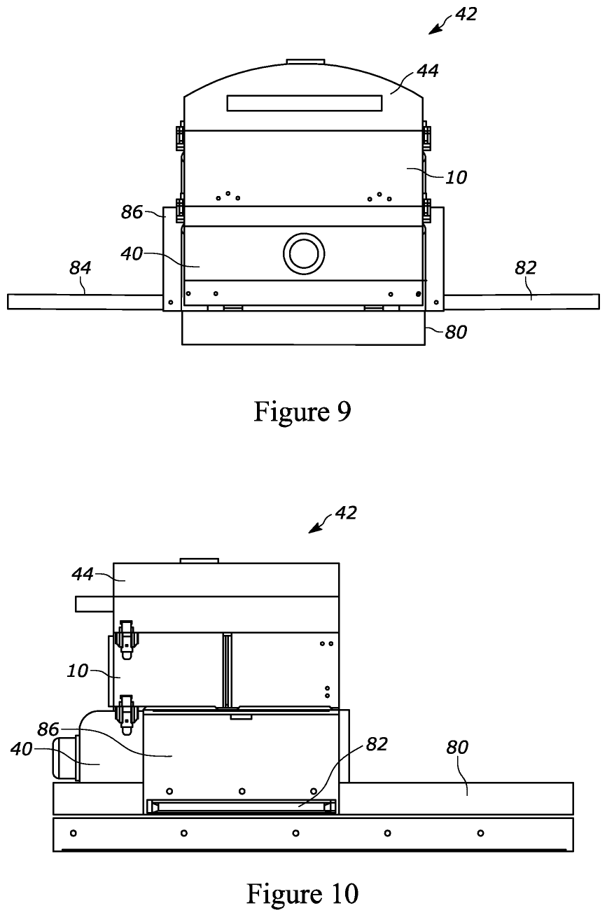

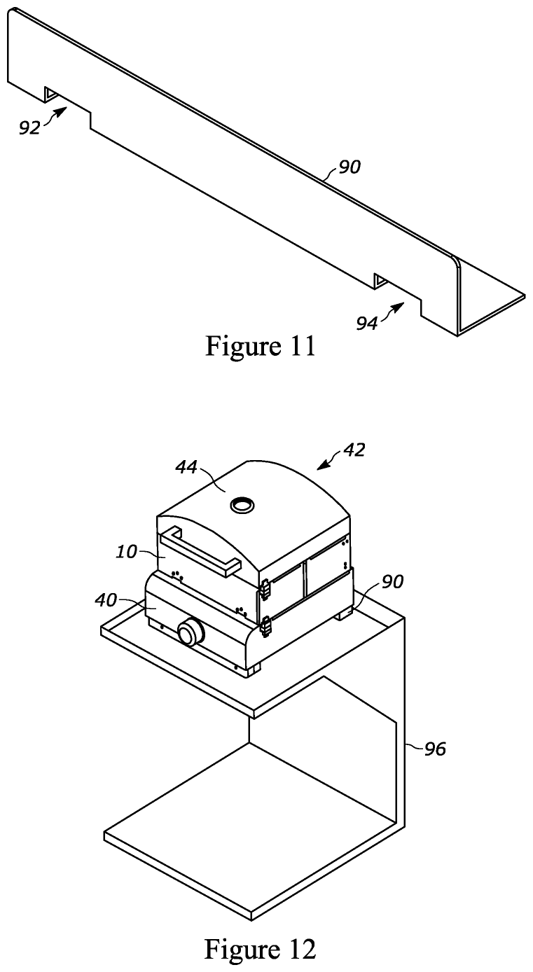

By this arrangement, the hood extension device 10, when in the opened condition, can be mounted on a base portion 40 of a portable BBQ 42 or pizza oven, and a hood 44 (or lid) of the same portable BBQ or pizza oven can be mounted on top of the hood extension device 10, as shown in FIGS. 2 to 4, 6 to 10, 12 to 14, 20 and 21, to provide a sealed, enlarged and protected cooking space within the portable BBQ 42 or pizza oven.

The hood extension device 10 can be used to create a roasting oven, as the hood extension device elevates the hood 44 from the base portion 40 sufficiently to enable a large roast, such as a whole chicken or a rotisserie arrangement, to fit under the hood 44 and on top of the base portion 40. The hood extension device 10 can also be used as a wind protector when food is being barbequed on the portable BBQ (i.e., when the hood is not being used) and when food is being roasted (i.e., when the hood is taken off or pivotally opened to allow inspection of the roast). Accordingly, the hood extension device 10 provides a versatility of use which allows the portable BBQ to be used for both barbequing and roasting.

The hood 44 of the BBQ 42 can be pivoted up and down very easily. It has two tongue hinges so there are no bolts or clips. These tongue hinges are located on the underside of the hood 44, at the rear. They simply slide into two slots at the top rear of the base portion 40 of the BBQ or at the top rear of the hood extension device 10. The hood 44 also has rear vents 46 for air circulation.

The top front of the base portion 40 of the portable BBQ 42 has two spring loaded clips 50, 52 (male members) on either side which, when the hood extension device 10 is not in use, can lock the hood 44 (which has female members at the bottom front thereof) shut against the base portion 40. When the hood extension device 10 is in use, two additional spring loaded clips 54, 56 (male members) mounted on either side at the top front of the hood extension device can lock the hood 44 (using the same female members) shut against the hood extension device. The two spring loaded clips 50, 52 (male members) at the top front of the base portion 40 can lock the hood extension device 10 (which has female members 57 at the bottom front thereof) shut against the base portion 40. These clips 50, 52, 54, 56 are especially useful during transportation.

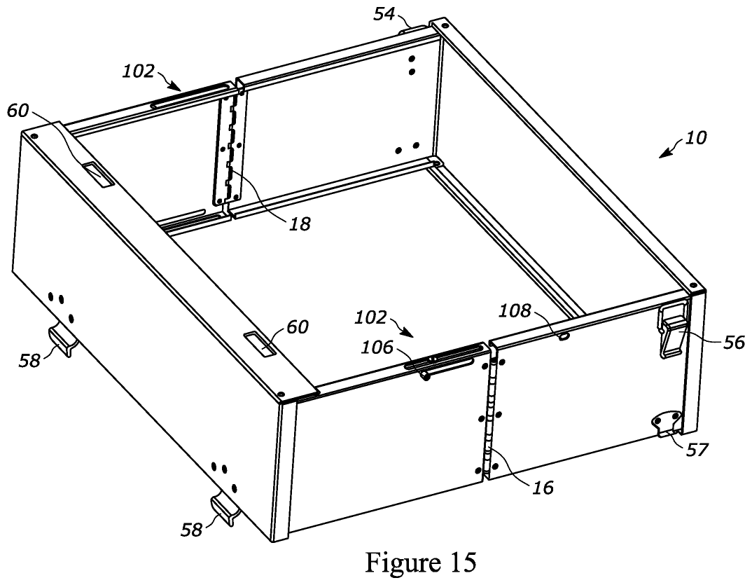

The hood extension device 10 is, in this embodiment, 80 mm high but can be any suitable height. When in the opened condition, the hood extension device 10 (see especially FIG. 15) has two tongue hinges 58 located on the underside at the rear thereof, which allow the hood extension device 10 to engage the top rear of the base portion 40 of the BBQ when the hood 44 is removed.

The hood 44 can now slip into two slots 60 at the top rear of the hood extension device so as to allow the hood 44 to sit 80 mm above the base portion 40 of the BBQ. This enables the portable BBQ 42 to be also used as an oven, say, for cooking full sized roasts and pizzas, and creates a wind break or barrier to prevent the wind extinguishing the flame.

In addition, if a front fold down door is fitted, an extra pizza rack and stone can be fitted and two pizzas cooked at the same time. This eliminates the need for a separate portable pizza oven.

As the hood 44 is easily removable from either the base portion 40 or from the hood extension device 10, and as the height of the base portion 40 is relatively low, the base portion 40 can easily fit into tight storage areas.

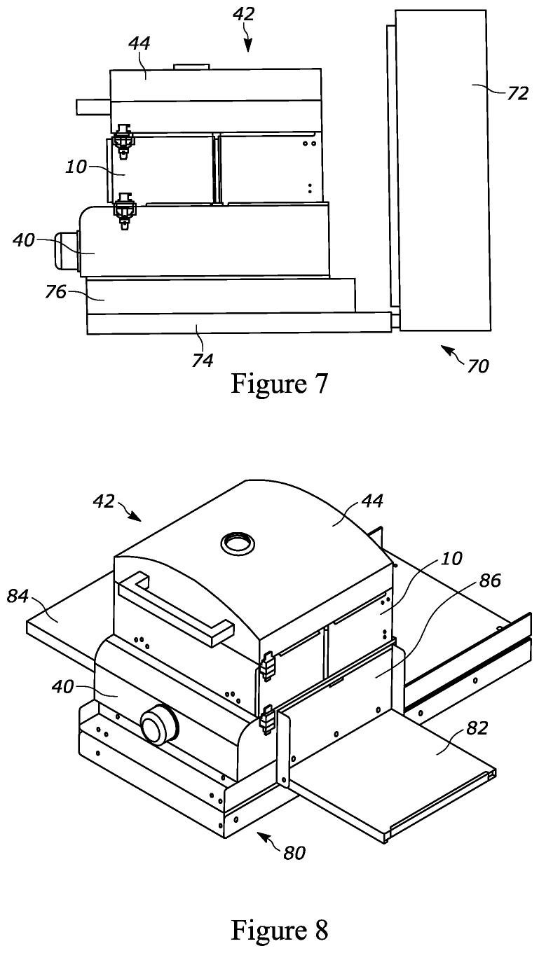

FIGS. 6 and 7 show a storage enclosure 70 or box that can be mounted, say, above the mudguard of a horse float, or on the side of any other trailer, and even on the rear of a caravan, or can be fitted in a externally accessible, space saving, compartment of such vehicles. Alternatively, the storage enclosure 70 can be mounted against, or in a compartment of, the wall of a balcony of a free standing house or apartment. The storage enclosure 70 has a deep walled part 72 that, as shown in FIGS. 6 and 7, is mounted for use in a vertical orientation, and has a pivotally connected lid part 74 to which the base portion 40 (and optionally a drawer slide system 76 of the storage enclosure 70) of the portable BBQ 42 is mounted. To open the storage enclosure 70, the lid part 74 folds down by 90° from the deep walled part 72 or, if the deep walled part 72 is not in a vertical orientation (such as when the trailer is on sloping ground), by an angle sufficient to bring it parallel to the ground. This allows the portable BBQ 42, and the drawer slide system 76 on which it is slidably mounted, to be parallel to the ground when the storage enclosure 70 is in the open position. The portable BBQ 42 can be slid outwardly from the lid part 74 in order to easily connect the gas supply and to remove and/or clean any fat collection trays from under the base portion 40.

The width of the storage enclosure 70 is, in this embodiment, a little more than twice that of the portable BBQ 42 so that the hood 44 can fit and be stored to the side of the mounted base portion 40. When so stored, the rear tongue hinges fit into appropriately positioned slots in either the deep walled part 72 or lid part 74, and the female members of the front spring loaded clips are also similarly used to lock the hood 44 into place. This creates stability within the closed, vertically orientated, storage enclosure 70 during storage and transportation. Also, during barbequing, the available space on the lid part 74 to the side of the mounted base portion 40 may be used as a preparation area. Such use may involve a chopping board to cut the food or simply the placement of the food. It can also involve the use of a removable sink to wash up afterwards. Also, a pizza stone 78 or other flat item is held in a compartment 79 on the deep walled part 72.

The storage enclosure 70 is not only space saving and easy to use, it offers ideal protection from pests, such as rodents, spiders, and cockroaches, as well as from pet animals which may be attracted by the smell of food. The storage enclosure 70 also protects its contents against dust, salty air, rain and other adverse weather conditions.

The drawer slide system 80 shown in FIGS. 8 to 10 allows the portable BBQ 42 to slide into and out of a suitably sized caravan storage compartment (normally a standard compartment of a standard size at the front of most Australian caravans). At each side of the portable BBQ 42 are foldable side trays 82, 84 which, when the BBQ is slid out of the compartment and locked into place and the side trays are folded outwardly, can support food and other items required for cooking. The side trays 82, 84 can be folded up alongside upright panels 86 adjacent to the portable BBQ 42 after use to serve as narrow storage compartments for a BBQ cast cooking plate and/or a pizza stone. The side trays 82, 84 can be locked into a vertical position to allow the drawer slide system 80 and the portable BBQ 42 mounted thereon to slide into the caravan storage compartment and then be locked into place for transportation. There may also be a slide out bench from under the portable BBQ 42 which is operably connected to, and may be a part of, the drawer slide system 80.

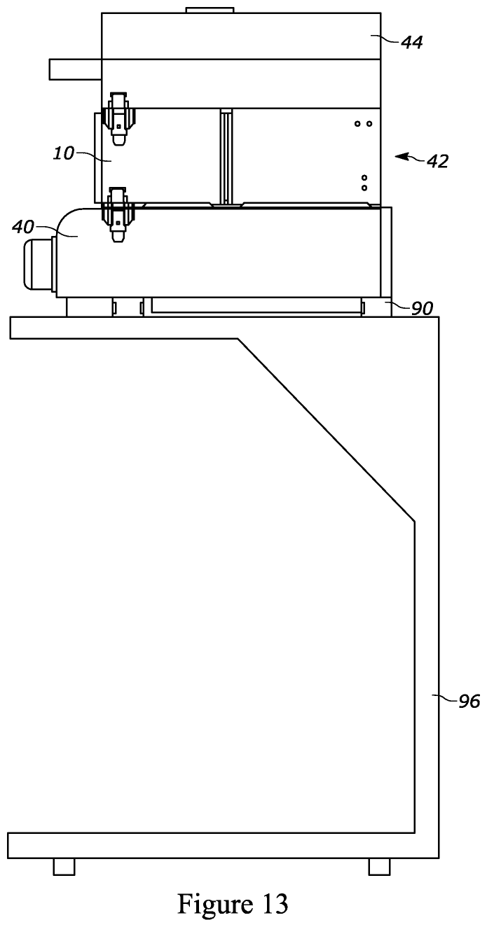

A rear lock bracket 90 of a locking clip system is shown in FIG. 11 for receiving the rear feet of a portable BBQ and pizza oven. The feet are designed to engage the openings 92, 94 of the lock bracket 90 by, for example, a hooking or clipping action, so that the portable BBQ 42 may be stably, but removably, locked in position on the above described storage enclosure 70 or drawer slide system 80, or on a fixed or mobile stand or trolley 96 (see FIGS. 12 and 13). This allows the portable BBQ to be unhooked or unclipped from these structures or from any other storage or supporting apparatus and be placed in a carry bag or other portable container for taking to a park, picnic area, beach or the like.

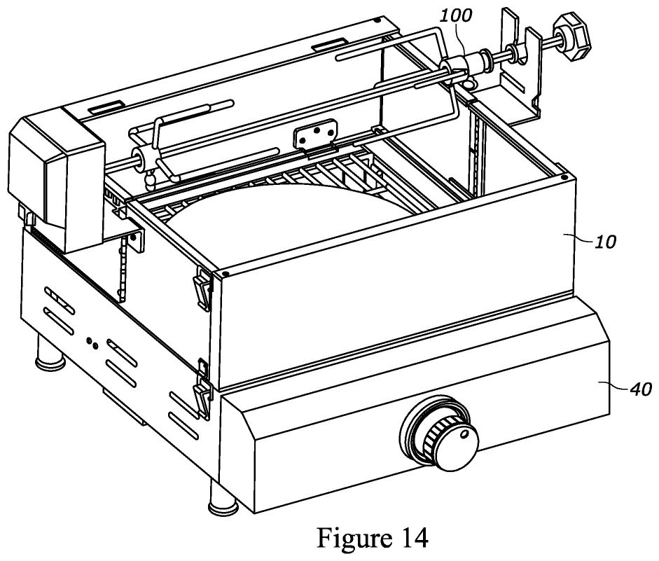

The hood extension device 10 can also be used to mount a rotisserie arrangement 100 as shown in FIG. 14. In this embodiment, the hood is removed for cooking purposes, but in an alternative embodiment the hood may be configured so as to fit over the rotisserie arrangement and enclose the food being cooked.

FIG. 15 shows the hood extension device 10 in greater detail and in an opened condition. It has the two spring loaded clips 54, 56 (male lock members) at the top front thereof which can lock the hood 44 (which has appropriately positioned female lock members) shut against the device 10. It also has female lock members 57 at the bottom front thereof which can lock the hood extension device 10 shut against the base portion (which has appropriately positioned male lock members). The device 10 has two tongue hinges 58, which are located on the underside at the rear of thereof, and allow the hood extension device 10 to engage the top rear of the base portion 40 of the BBQ when the hood 44 is removed. The hood 44 can then slip into two slots 60 at the top rear of the hood extension device 10. There are two opposed slide lock arrangements 102 shown in FIG. 15 for locking the hood extension device 10 in the opened condition. The concertina-like folding for opening and closing of the device 10 is facilitated by 180° piano hinges 16, 18. There is also an alignment arrangement of a pin 106 and a hole 108 which serves to ensure that the device 10 is properly (and fully) in the closed condition when required.

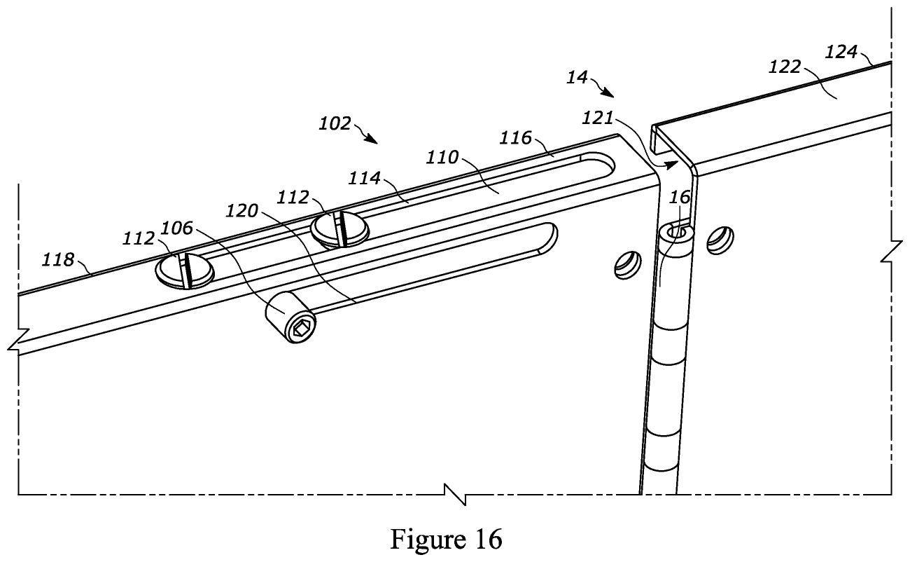

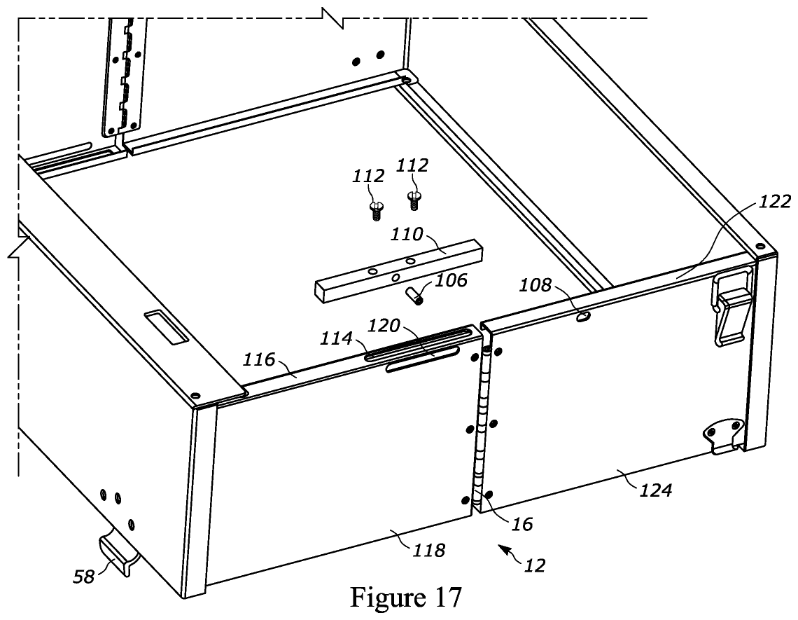

As can be seen in FIGS. 15 and 16, each slide lock arrangement 102 comprises a slide bar 110, a pair of screws 112, the pin 106, an upper track 114 along the top of the upper surface 116 of one of the two panels (panel 118) of a foldable side wall 12, 14, a side track 120 along an outer side surface of the panel 118, and a receiving channel 121 along the bottom of the upper surface 122 of the other one of the two panels (panel 124) of that foldable side wall 12, 14. The slide bar 110, screws 112 and pin 106 are independently shown in FIG. 17 after having been removed from their operable positions, for ease of understanding. The purpose of the screws 112 (which are partly screwed into, and can slide with, the slide bar 110) is to hold the slide bar 110 properly in place in a channel along the bottom of the upper surface 116 of the panel 118. The pin 106 is affixed to the outer side of the slide bar 110 and serves as a handle.

The slide bar 110, when it is in a “ready to lock” position in the channel of the panel 118 as shown in FIGS. 15 and 16, can be manually slid into the receiving channel 120 of the panel 124 by gripping the pin 106 and moving the pin 106 (and the attached slide bar 110) from the left end to the right end of the side track 120, thereby locking the device 10 in the opened condition. The extent of sliding movement for such locking is limited by the length of the side track 120 (when the pin 106 reaches the right end of that track 120) or by the length between the right-most screw 112 and the right end of the upper track 114 (when the right-most screw 112 reaches the right end of that track 114).

For the device 10 to assume the closed condition from the opened condition, the slide bar 110 is slid in the opposite direction, so as to allow for the concertina-like folding inwardly of the side walls 12, 14, facilitated by the 180° piano hinges 16, 18, and the closing of the device 10. When the device 10 is properly (and fully) in the closed condition, say, for storage and transportation, the pin 106 (which is in its left most position) will be aligned with the hole 108 and will extend through that hole. This engagement will be visible or otherwise apparent to a user. If no such engagement occurs, then the device 10 is not properly (and fully) in the closed condition, and the user can correct the problem.

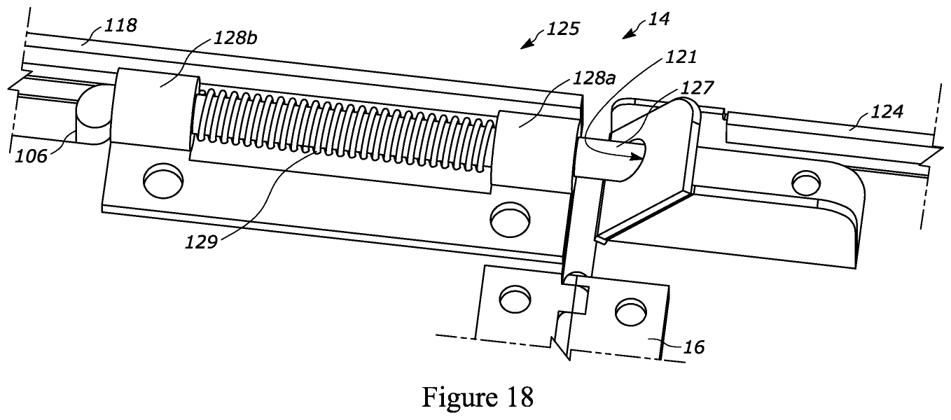

FIG. 18 shows a spring lock arrangement 125 which can replace each slide lock arrangement 102. Features of the spring lock arrangement 125 which are functionally similar to features of the slide lock arrangement 102 have been given like numerals. A rod 126 with a pin 106 at one end, has an opposite leading end 127 which can enter, and be withdrawn from, a circular receiving channel 121 formed on panel 124. There are two tubes 128a, 128b which hold and align the rod 126 with the receiving channel 121. Between the tubes 128a, 128b is a coil spring 129 which surrounds the rod 126. The coil spring 129 urges the rod 126 to engage the receiving channel 121 when the device is to be locked in the opened position. For the device 10 to assume the closed position, a user grips the pin 106 and pulls the rod 126 away from the receiving channel 121 against the force of the coil spring 129.

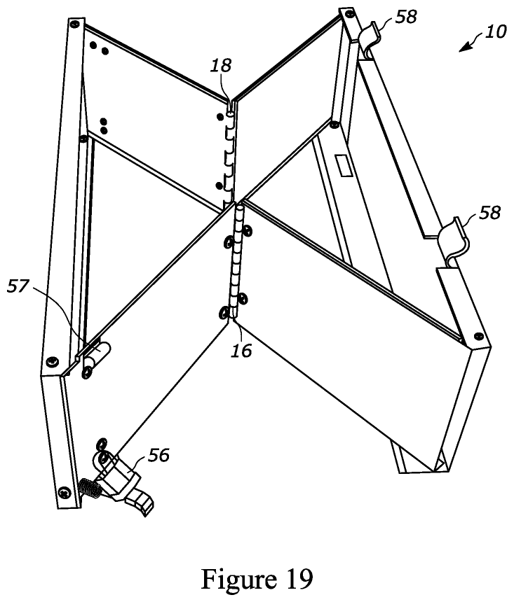

FIG. 19 shows a hood extension device 10 (albeit upside down) which has been folded inwardly, concertina-like, to assume a partly closed condition.

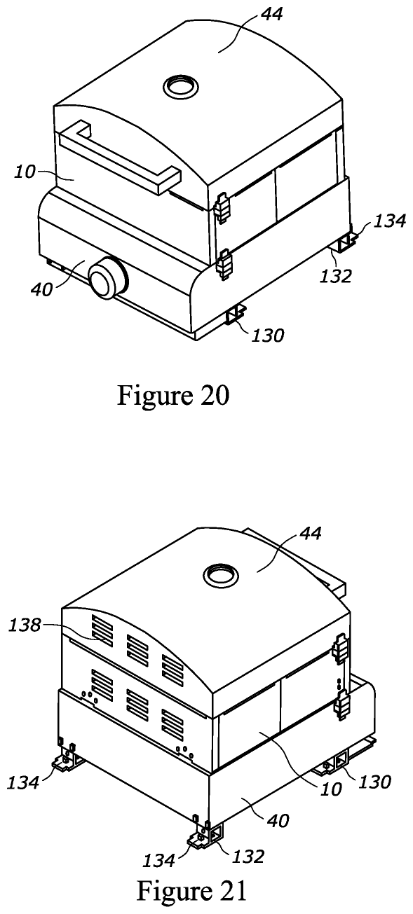

The assembly shown in FIGS. 20 and 21 has bracket assemblies 130, 132 connected to the front and rear, respectively, of the bottom of the base portion 40. The rear bracket assembly 132 has rear feet 134 which may be received in the rear lock bracket 90 of a locking clip system as shown in FIG. 11. The feet 134 may engage the openings 92, 94 of the lock bracket 90 by, for example, a hooking or clipping action. FIG. 21 shows that the hood extension device 10 has rear vents 138 for air circulation.

It will be readily apparent to persons skilled in the art that various modifications may be made in details of design and construction of the portable barbeques and pizza ovens described above without departing from the scope or ambit of the present inventions.

1. A hood extension device for a portable BBQ or pizza oven, the device comprising four interconnected side walls forming a four cornered frame when the device is in an opened condition for use, a first opposed pair of the side walls having 180° hinges located half way along their length, and each of the four corners have 90° hinges, the arrangement being such that the first opposed pair of the side walls can be folded inwardly, concertina-like, when required for the device to assume a closed condition for easy flat-pack storage and transportation, and can be folded outwardly when required for the device to assume the opened condition for use, whereby the device can be mounted on a base portion of a portable BBQ or pizza oven, and a hood of the same portable BBQ or pizza oven can be mounted on top of the device to provide a sealed, enlarged and protected cooking space within the portable BBQ or pizza oven.

2. A storage enclosure for a portable BBQ and pizza oven, the storage enclosure comprising a deep walled part that is mounted for use in a vertical orientation, and a pivotally connected lid part to which a base portion, and optionally a drawer slide system of the storage enclosure, of the portable BBQ or pizza oven is mounted, whereby, to open the storage enclosure, the lid part folds down to bring it parallel to the ground so that the portable BBQ or pizza oven is parallel to the ground, and wherein the width of the storage enclosure is a little more than twice that of the portable BBQ or pizza oven so that a hood of the portable BBQ or pizza oven can fit and be stored to the side of the mounted base portion.

3. A drawer slide system for a portable BBQ and pizza oven, the system comprising a first reference surface below the portable BBQ or pizza oven and relative to which a second movable surface upon which the portable BBQ or pizza oven is mounted can slide into and out of a storage compartment.

4. The system of claim 3, wherein at each side of the portable BBQ or pizza oven are foldable side trays which, when the portable BBQ or pizza oven is slid out of the storage compartment and locked into place, can be folded outwardly to support food and other items required for cooking, and wherein the side trays can be folded up alongside the portable BBQ or pizza oven after use and locked into a vertical position to serve as narrow storage compartments.

5. A locking clip system for a portable BBQ and pizza oven, the system comprising a rear lock bracket secured to a surface upon which the portable BBQ or pizza oven is supported, the rear lock bracket being adapted to receive one or more rear feet of the portable BBQ or pizza oven so as to stably, but removably, lock the portable BBQ or pizza oven in position on the surface, and wherein the portable BBQ or pizza oven can be unclipped from the surface and, optionally, be placed in a carry bag for taking elsewhere.
